(19) United States
(12) Patent Application Publication
(10) Pub. No.: US 2009/0220066 A1
(43) Pub. Date: Sep. 3, 2009

(54) SYSTEM AND METHOD FOR SEAMLESS TRANSITION OF A CONFERENCE CALL PARTICIPANT BETWEEN ENDPOINTS

(75) Inventors: Shmuel Shaffer, Palo Alto, CA (US); Steven L. Christenson, Campbell, CA (US); Gebran G. Chahrouri, Menlo Park, CA (US)

Correspondence Address: Patent Capital Group - Cisco, 6119 McCommas, Dallas, TX, 75214, US

(73) Assignee: Cisco Technology, Inc., San Jose, CA (US)

(21) Appl. No.: 12/039,868

(22) Filed: Feb. 29, 2008

(51) Int. Cl. H04M 3/56

(52) U.S. Cl. 379/204.01

(57) ABSTRACT

In one embodiment, a method includes maintaining a first connection with respect to a conference call on a first endpoint associated with a user. The method also includes determining if the user has requested a second connection with respect to the conference call, and establishing the second connection with respect to the conference call if the user has requested the second connection. Finally, the method includes replacing the first connection with the second connection with respect to the conference call if the user has requested the second connection. Replacing the first connection with the second connection includes establishing the second connection with respect to the conference call through a second endpoint associated with the user. The second connection is established transparently with respect to the conference call, and replaces the first connection transparently.

### BACKGROUND OF THE INVENTION

The present invention relates generally to networking architectures.

Conference call technology allows participants to call into, or otherwise take part in, a conference call from substantially anywhere. A conference participant may access a conference bridge using substantially any telephone or computing device. By way of example, a participant may join a conference call using a telephone located at his or her workplace, a telephone located at his or her home, or generally any telephone at any location.

A conference call participant may utilize a mobile device, e.g., a mobile or cellular telephone, to join a conference call. In many instances, a participant may call into an early morning conference using a mobile telephone while driving to work. When such a participant reaches work, he or she may wish to switch from participating in the conference using a mobile telephone to participating in the conference using a fixed line or a voice over internet protocol (VoIP) telephone such as a desk telephone. Alternatively, a participant may wish to switch from participating in the conference using a mobile telephone to participating in the conference using a line, e.g., a hands-free conferencing phone, that is already in use by others participating in the conference. Switching to a desk telephone or a conferencing phone may be desired by a participant because of the better voice quality associated with desk telephones, and/or because of the costs associated with calls placed from mobile telephones. In order to switch from a mobile telephone to a desk telephone, a participant may hang up his or her mobile telephone, dial into the conference using his or her desktop telephone, and establish a connection to the conference using his or her desktop telephone.

Typically, when a participant joins a conference call, the presence or attendance of the participant may be announced to substantially all participants in the conference call. For example, an announcement of “Now joining the conference call, Participant A” may be played upon the participant joining the conference call. Similarly, when a participant exits or disconnects from a conference call, his or her exit from the conference may be announced to substantially all participants in the conference call. For example, an announcement of “Now leaving the conference call, Participant A” may be played upon the participant exiting the conference call. Such announcements generally take up airtime associated with the conference call, as conference call proceedings may not be heard while announcements are played. Hence, when a participant exits a conference call using a mobile device, then effectively reconnects to the conference call using a desktop phone, his or her exit from the conference call will be announced, followed relatively shortly by an announcement that he or she has rejoined the conference call.

### BRIEF DESCRIPTION OF THE DRAWINGS

The invention will be readily understood by the following detailed description in conjunction with the accompanying drawings, wherein like reference numerals designate like structural elements, and in which:

FIG. 1A is a block diagram representation of a system at a time t1 during which a participant initially maintains a first connection to a conference call using a first device in accordance with an embodiment of the present invention.

FIG. 1B is a block diagram representation of a system, e.g., system 100 of FIG. 1A, at a time t2 during which an attempt is made to create a second connection to a conference call for a participant, e.g., participant 104 of FIG. 1A, using a second device in accordance with an embodiment of the present invention.

FIG. 1C is a block diagram representation of a system, e.g., system 100 of FIG. 1A, at a time t3 at which a second connection to a conference call is initiated using a second device, e.g., second device 108b of FIG. 1B, in accordance with an embodiment of the present invention.

FIG. 1D is a block diagram representation of a system, e.g., system 100 of FIG. 1A, at a time t4 at which a first connection to a conference call which utilizes a first device, e.g., first device 108a of FIG. 1A, in accordance with an embodiment of the present invention.

FIG. 2 is a block diagram representation of a conference call system which provides for a seamless transition of a conference call participant between endpoints in accordance with an embodiment of the present invention.

FIG. 3 is a process flow diagram which illustrates a first method of participating in a conference call in accordance with an embodiment of the present invention.

FIG. 4 is a process flow diagram which illustrates a second method of participating in a conference call in accordance with an embodiment of the present invention.

FIGS. 5A and 5B are a process flow diagram which illustrates a method of processing a request for an alternative connection to a conference call in accordance with an embodiment of the present invention.

FIG. 6 is a process flow diagram which illustrates a method of determining whether a request obtained for a connection to a conference call is a request obtained from a participant who already has an established connection, e.g., step 509 of FIG. 5A, in accordance with an embodiment of the present invention.

FIGS. 7A and 7B are a process flow diagram which illustrates a method of processing a request for an alternative connection to a conference call in a system in which there is a fixed number of participants in accordance with an embodiment of the present invention.

FIG. 8 is a process flow diagram which illustrates a method of seamlessly transitioning from a conference call connection associated with a first device to an existing conference call connection from the point of view of a participant in accordance with an embodiment of the present invention.

FIGS. 9A and 9B are a process flow diagram which illustrates a method of seamlessly transitioning from a conference call connection associated with a first device to an existing conference call connection from the point of view of a conference call system in accordance with an embodiment of the present invention.

### DESCRIPTION OF EXAMPLE EMBODIMENTS

### General Overview

According to one aspect of the present invention, a method includes maintaining a first connection with respect to a conference call on a first endpoint associated with a user. The method also includes determining if the user has requested a second connection with respect to the conference call, and establishing the second connection with respect to the conference call if the user has requested the second connection. Finally, the method includes replacing the first connection with the second connection with respect to the conference call if the user has requested the second connection. Replacing the first connection with the second connection includes establishing the second connection with respect to the conference call through a second endpoint associated with the user. The second connection is established transparently with respect to the conference call, and replaces the first connection transparently.

### Description

The playing of an announcement by a conference call system when a conference call participant exits a conference call by hanging up one telephone device, followed substantially immediately by the playing of another announcement when the conference call participant joins the conference call using another telephone device wastes airtime, particularly since the conference call participant effectively never intended to “leave” the conference call. Rather, the conference call participant was transitioning from one conference call endpoint to another conference call endpoint.

In one embodiment, a conference call system may apply and support different policies associated with an announcement process. That is, a conference call system may determine when to trigger, and when not to trigger, the playing of announcements. For example, announcements regarding the status of a participant may be played when it is determined that the participant has joined a conference call for a first time, and/or when it is determined that a participant has terminated a connection with the conference call that uses a first device and has substantially no known intent to join the conference call using a different device.

A stealth endpoint-exchange, or seamless transition functionality, may essentially be invoked when a conference call participant would like to continue to participate in a conference call, but from a different endpoint or using a different device. Using the stealth endpoint-exchange, an overall conference call system may identify the conference call participant as intending to change endpoints, e.g., switch from participating in a conference call using a first device to participating in the conference call using a second device, and, hence suppress the triggering of an announcement process. By suppressing the triggering of an announcement and, hence, eliminating the playing of an announcement when a first device associated with a participant is effectively disconnected from a conference and when a second device associated with the participant effectively connects to the conference call, the amount of wasted airtime may be reduced.

The seamless transition between endpoints associated with a particular participant may be implemented in a conference call system that recognizes the particular participant as being associated with, or effectively “owning,” endpoints or devices. When the conference call system recognizes that the particular participant has a connection to a conference call through a first device, and is requesting a connection to the conference call through a second device, the conference call system may establish the connection to the conference call through the second device, and also substantially prevent an announcement process from being triggered. That is, an announcement process is not triggered when a participant switches between two devices.

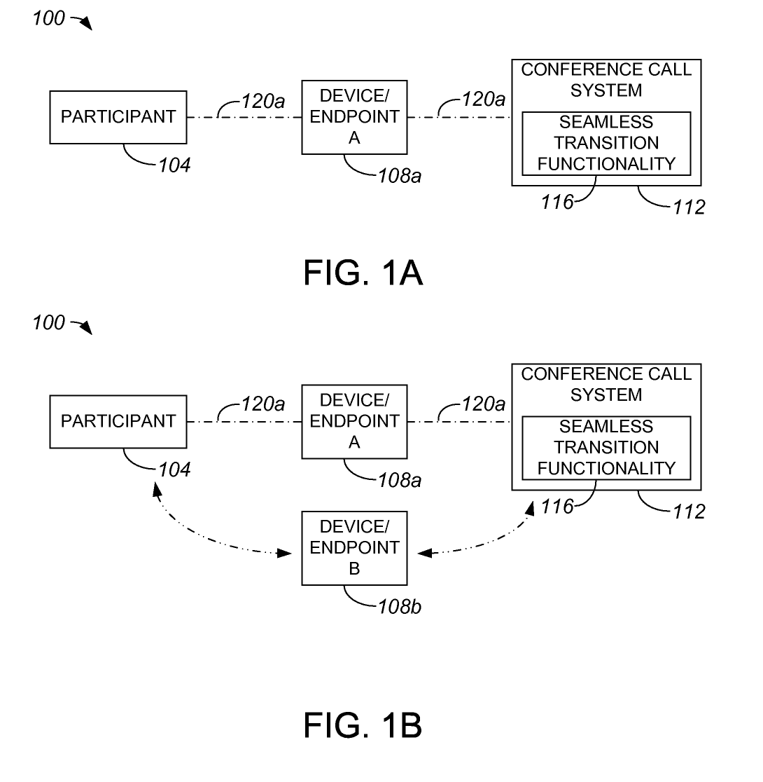

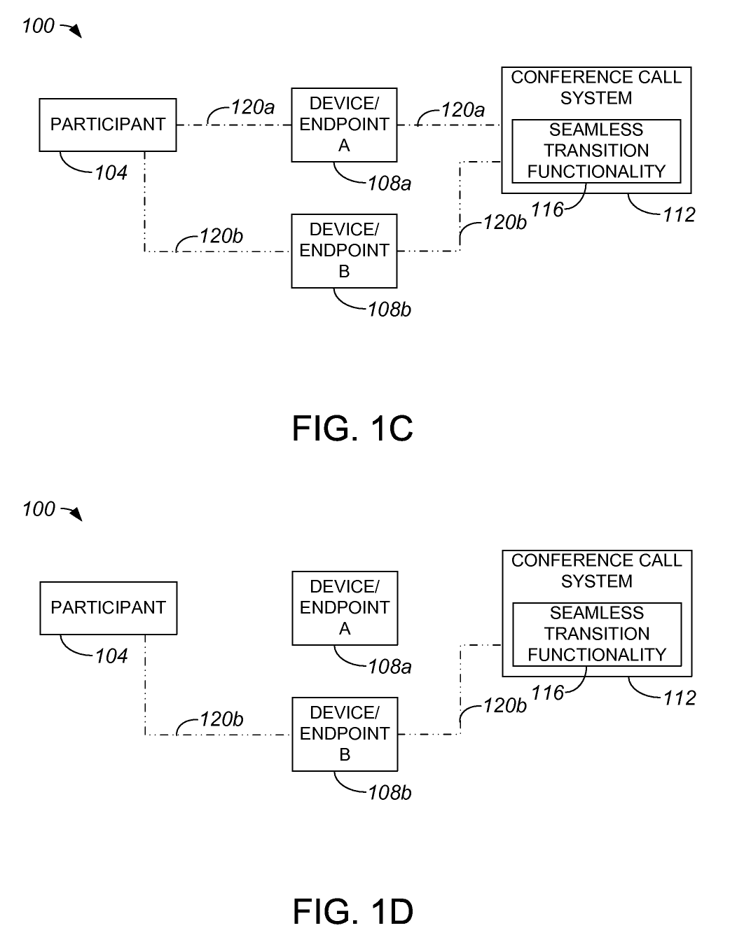

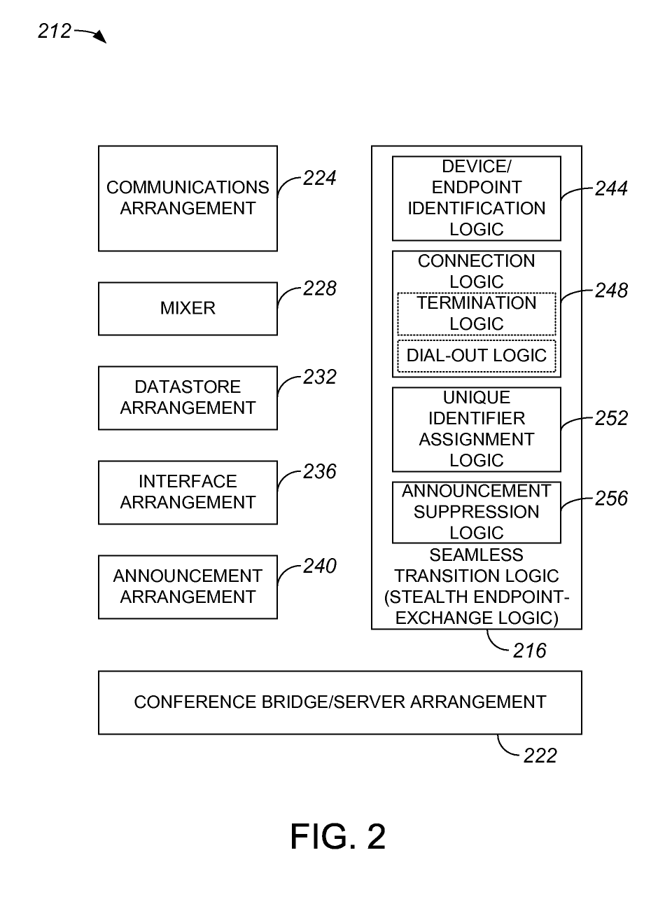

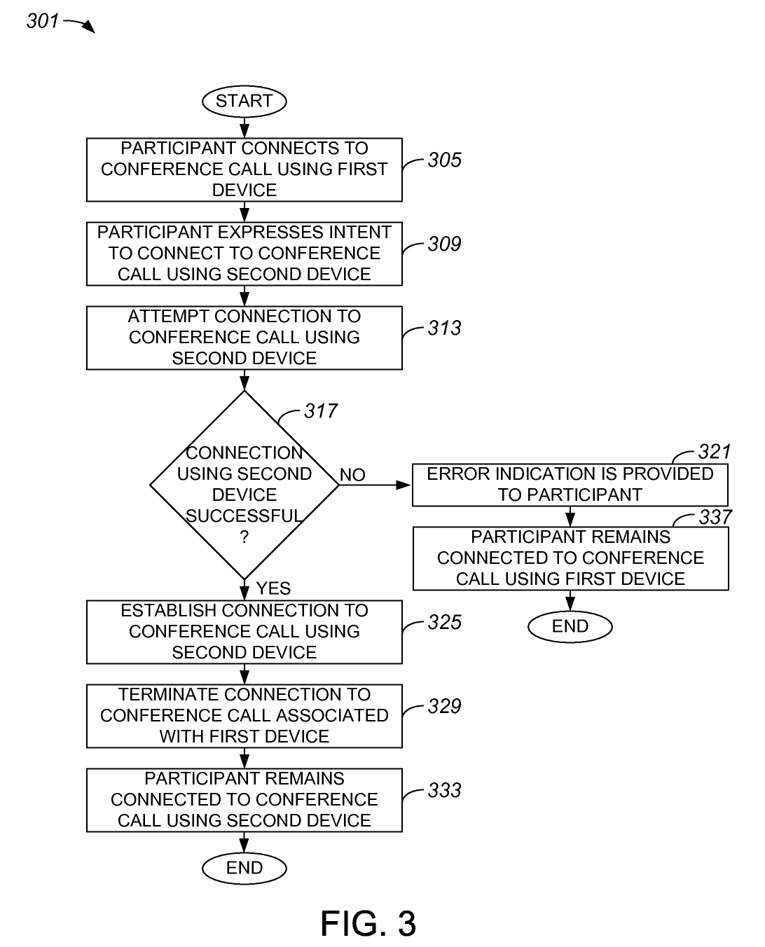

With reference to FIGS. 1A-1D, the use of a conference call system to enable a seamless transition between endpoints during a conference call will be described in accordance with an embodiment of the present invention. FIG. 1A is a block diagram representation of an overall system at a time t1 during which a participant initially maintains a first connection to a conference call using a first device. An overall system 100 includes a conference call system 112 which has seamless transition functionality 116. Seamless transition functionality 116 is arranged to allow a participant 104 to switch between different devices or endpoints while on a conference call such that the switch is essentially transparent, e.g., not announced to other participants on the conference call.

At a time t1, a participant 104 has a connection 120a to conference call system 112 through or using a device or endpoint 108a. Connection 120a effectively enables participant 104 to participate in a conference call supported by conference call system 112 using device 108a. Device 108a may be substantially any device that may be used for conferencing purposes including, but not limited to including, a mobile telephone, a landline telephone, a voice over internet protocol (VoIP) telephone such as a soft phone, and a computing device which is arranged to provide telephone services. Typically, the portion of connection 120a between endpoint 108a and conference call system 112 is a physical connection, whereas the overall connection between participant 104 and conference call system 112 may be considered to be a logical connection, as will be understood by those skilled in the art.

At a time t2, as shown in FIG. 1B, participant 104 attempts to obtain an alternate connection to a conference call supported by conference call system 112. The participant 104 attempts to obtain the alternate connection through a device or endpoint 108b. While participant 104 attempts to obtain an alternate connection through device 108b, connection 120a is maintained. It should be appreciated that when participant 104 indicates to conference call system 112 that participant 104 wishes to transition from connection 120a to an alternate connection that uses device 108b, the alternate connection may be initialized either by conference call system 112 or by participant 104. By way of example, conference call system may dial a telephone number associated with device 108b and wait for participant 104 to answer, or participant may use device 108b to dial into conference call system 112.

In one embodiment, devices 108a, 108b are both effectively known to be assigned to, owned by, or otherwise associated with participant 104 such that conference call system 112 is aware that by attempting to connect to a conference call through device 108b, participant 104 is effectively initiating an endpoint-exchange or a transition from device 108a to device 108b. Participant 104 may indicate to conference call system 112, e.g., through a user interface associated with conference call system 112, that participant 104 is associated with both device 108a and device 108b. Alternatively, conference call system 112 may include a datastore arrangement (not shown) which indicates that devices 108a, 108b are both associated with participant 104.

A successful connection is made between participant 104 and conference call system 112 at a time t3. FIG. 1C is a representation of a system 100 at a time t3 in accordance with an embodiment of the present invention. At a time t3, a connection 120b through device 108b is established. As shown, connection 120a is also still established. It should be appreciated, however, that connections 120a, 120b are generally both in existence substantially only for an instant. In one example embodiment, connection 120a is torn down essentially as soon as connection 120b is established. That is, the original call associated with connection 120a may effectively be placed on hold and/or removed from the conference call upon the establishment of connection 120b.

At a time t4, which is typically immediately after a time t3, participant 104 no longer maintains connection 120a to conference call system 112 through device 108a. That is, connection 120a has been terminated. At time t4, participant 104 is connected to a conference call supported by conference call system 112 through device 108b and connection 120b. In the described embodiment, seamless transition functionality 116 is arranged such that other participants (not shown) who are on the same conference call as participant 104 are unaware of the transition of participant from connection 120a through device 108a, as shown in FIG. 1A, to connection 120b through device 108b. If conference call system 112 includes functionality (not shown) that is generally arranged to announce when any participant has joined or left a conference call, such functionality may be suppressed by seamless transition functionality 116 to prevent other participants (not shown) from being aware of the switch or transition of participant 104 to connection 120b.

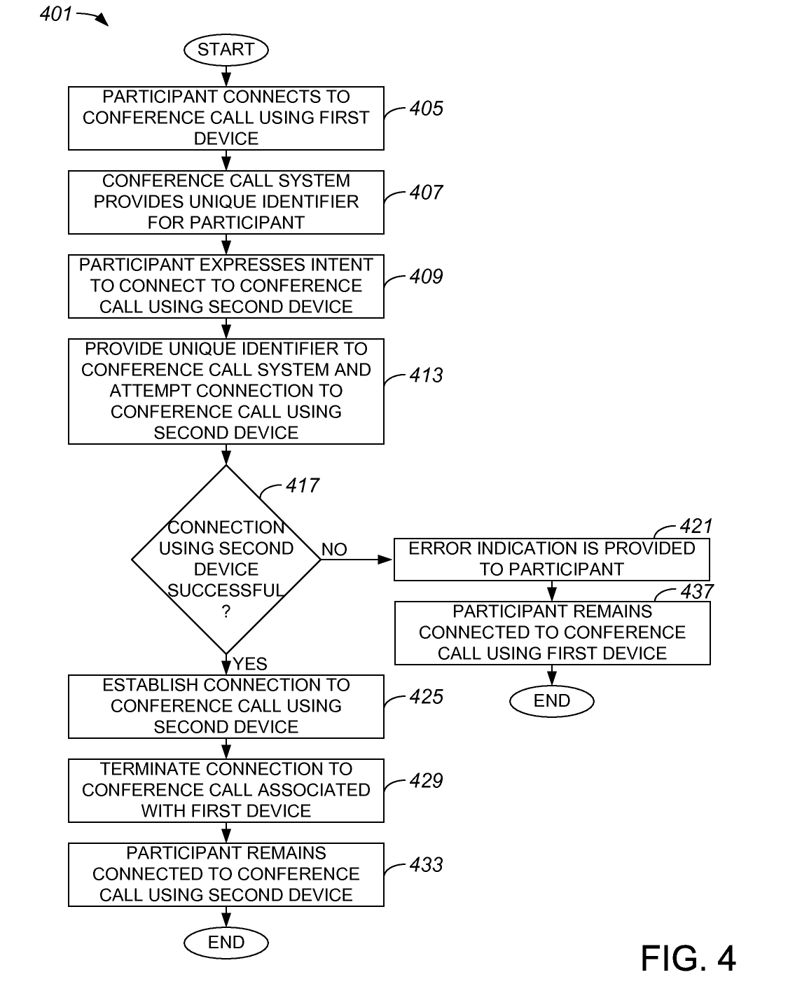

Referring next to FIG. 2, one embodiment of a conference call system that includes seamless transition logic will be described in accordance with an embodiment of the present invention. A conference call system 212 includes a conference bridge arrangement 222 that is generally arranged to link communications lines such that participants associated with the communications lines may participate in a conference call. Conference bridge arrangement 222 may include hardware and/or software logic embodied in a tangible media that is operable to support a conference call.

Conference call system 212 also includes a communications arrangement 224 that allows participants to access, e.g., dial into, conference bridge arrangement 222. Communications arrangement 224 also receives and outputs multimedia streams such as audio and/or video signals to various conference call participants. A mixer 228 includes logic which mixes audio and/or video signals provided through communications arrangement 224.

Conference call system 212 also includes hardware and/or software logic associated with a datastore arrangement 232, an interface arrangement 236, and an announcement arrangement 240. Datastore arrangement 232 may store information relating to potential participants in a conference call. In one embodiment, datastore arrangement 232 provides information that identifies each member of an enterprise who may potentially utilize conference call system 212 and information that identifies devices associated with each member of the enterprise. While datastore arrangement 232 may include a datastore that stores information, datastore arrangement 232 may instead be configured to access an external datastore in which information is stored. Interface arrangement 236 provides a user interface that enables a user, e.g., a participant on a conference call, to provide input to conference call system 212. By way of example, interface arrangement 236 may provide various menus which prompt a user to select, or otherwise enter, a telephone number of a device to which the user wishes to transition to. Announcement arrangement 240 is configured to provide announcements relating to the status of various participants on a conference call. Typically, announcement arrangement 240 may announce when a participant has joined a conference call, and also announce when a participant has left a conference call.

Seamless transition logic 216, or stealth endpoint-exchange logic, may generally include hardware and/or software logic embodied in a tangible media. Seamless transition logic 216 includes device or endpoint identification logic 244 which is configured to identify when a particular participant, who has two associated devices and is already in communication with conference call system 212 through one of the devices, indicates a wish to establish a second connection with conference call system 212 through another device. Device or endpoint identification logic 233 may also be configured to ascertain a telephone number associated with a device to which a participant wishes to connect to a conference call.

Connection logic 248, which is also included in seamless transition logic 216, is configured to allow a participant to make an alternative connection to conference call system 212. Connection logic 248 may cause a telephone number associated with an alternative device to be dialed such that an alternative connection may be established, and may cause a previous connection with an original device to be substantially disconnected.

Seamless transition logic 216 also includes unique identifier assignment logic 252 and announcement suppression logic 256. Unique identifier assignment logic 252 assigns a unique identifier for a participant who has joined a conference call. When a participant who has a unique identifier attempts to transition from one device to another devices, device endpoint identification logic 244 may obtain the unique identifier and determine that the participant is actually attempting an endpoint-exchange, i.e., that both devices are associated with the same participant. Announcement suppression logic 256 is configured to substantially prevent announcement arrangement 240 from making status announcements when an endpoint-exchange or a transition from one device to another device is made. That is, announcement suppression logic 256 is arranged to prevent a “leaving” announcement from being broadcast on a conference call when a participant transitions away from a first device and to prevent a “joining” announcement from being broadcast when the participant transitions to a second device, as the participant has effectively not changed his or her status with respect to being present on the conference call.

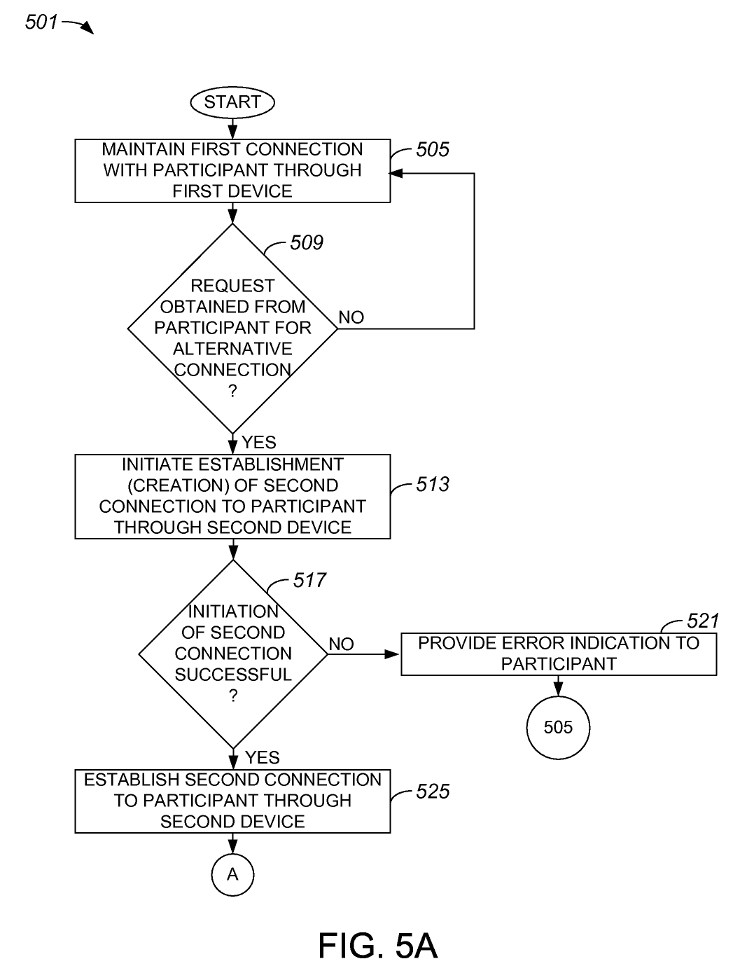

When a conference call participant wishes to transition from using a first device to using a second device during a conference call, the conference call participant may interact with a conference call system to effectuate the transition. FIG. 3 is a process flow diagram which illustrates a first method of participating in a conference call in accordance with an embodiment of the present invention. A process 301 of participating in a conference call from the point of view of a participant begins at step 305 in which the participants connects to the conference call using a first device. By way of example, a participant may dial into a conference bridge, and enter appropriate conference call identifying information, using a first device that is a mobile device.

After the participant connects to the conference call using the first device, the participant expresses an intent in step 309 to connect to the conference call using a second device. The participant may access a menu, e.g., a breakout menu, using the first device or a computing system that may be used to access a conference call system, to indicate an intent to connect to the conference call using the second device. An intent to connect to the conference call using a second device may include interacting with an interface to specify information which indicates that the participant wishes to transition from the first device to the second device. Such an interface may be menu-driven, and may be implemented by a conference call system on a computing device and/or on the first device. In one embodiment, a menu may allow the participant to input a telephone number for the second device, or an alternative telephone number. In another embodiment, a menu may provide the participant with a list of devices which are effectively known to be associated with or owned by the participant, and allow the participant to select the second device from the list. When the participant is a known member of an enterprise associated with the conference call system, the conference call system may be substantially preconfigured such that the conference call system is able to identify a set of devices which are owned by the participant and, hence, be able to present a list of such devices in a menu.

Once the participant expresses an intent to connect to the conference call using the second device, an attempt is made to connect to the conference call using the second device in step 313. The conference call system may dial a telephone number associated with the second device in an attempt to connect the participant to the conference call through the second device, or the participant may attempt to dial into the conference call via a conference bridge using the second device in an effort to connect to the conference call. It should be appreciated if the participant attempts to dial into the conference call using the second device, the participant may have to provide appropriate conference call identifying information, as well as a new conference call identifier.

A determination is made in step 317 as to whether a connection to the conference call through the second device was successful. If it is determined that the connection to the conference call through the second device was successful, process flow moves to step 325 in which the connection to the conference call through the second device is established. In other words, the participant effectively joins the conference call using the second device. Then, in step 329, the connection to the conference call associated with the first device, i.e., the connection made in step 305, is dropped or otherwise terminated. The termination of the connection may generally be initiated by either the participant or the conference system. In one embodiment, the connection associated with the first device may be substantially automatically terminated by the conference system in the event that the participant fails to terminate the connection after a predetermined amount of time has expired. After the connection to the conference call associated with the first device is terminated, the participant remains connected to the conference call through the second device in step 333, and the process of participating in a conference call is completed.

Returning to step 317, if it is determined that the connection to the second device was not established successfully, then an error indication is provided to the participant in step 321. It should be appreciated that the participant may be the only party who would receive or otherwise obtain the error indication, e.g., an error indication may be played substantially only for the first device. Such an error indication may notify the participant of an inability of the second device to be connected to a conference call. After the error indication is provided, the participant remains connected to the conference call through the first device in step 337, and the process of participating in a conference call is completed.

To facilitate the transition between endpoints or devices associated with a conference call participant, a conference call system may provide a unique identifier for a conference call participant. Such a unique identifier may then be used during an endpoint-exchange process to identify the participant as being associated with both a first device and a second device. In one embodiment, a unique identifier may be assigned to an unknown “guest” who joins a conference call, as a conference call participant may otherwise be unable to identify devices which are associated with such a guest.

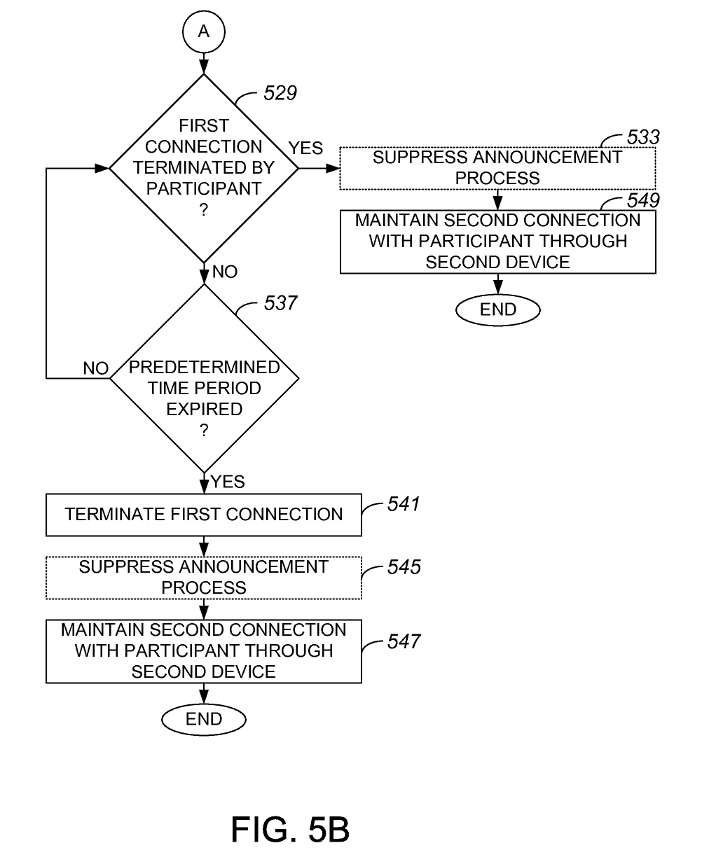

FIG. 4 is a process flow diagram which illustrates a second method of participating in a conference call which includes the assignment of a unique identifier to a conference call participant in accordance with an embodiment of the present invention. A process 401 of participating in a conference call begins at step 405 in which a participant connects to a conference call using a first device. The participant may generally connect to a conference call using any suitable method.

Once the participant joins the conference call using the first device, the conference call system which supports the conference call provides a unique identifier to the participant in step 407. That is, the participant obtains a unique identifier from the conference call system. The unique identifier may be arranged to effectively identify the participant, and may be provided to the participant via the first device and/or a computing device that may be used to access the conference call system. In one embodiment, a recording which recites the unique identifier may be played for the participant on the first device. In another embodiment, a recording which recites the unique identifier may be played to the participant substantially only after her or she selects a menu option indication his or her desire to re-establish participation in the conference call via another endpoint.

In step 409, the participant expresses an intent to connect to the conference call using a second device. The intent may be expressed, or otherwise indicated, by accessing breakout menus associated with the conference call system, and interacting with the menus. Typically, the participant may indicate a telephone number associated with the second device, as well as the unique identifier.

After the participant expresses an intent to connect to the conference call using a second device, the participant connects to the conference call using the second device in step 413. In one embodiment, the process of connecting to the conference call involves providing the unique identifier to the conference call system. By indicating the unique identifier to the conference call as a part of a connection process using the second device, the participant effectively identifies the second device as, like the first device, being associated with the participant. Hence, the attempt to connect to the conference call using the second device may be identified as an attempt by the participant to transition from the first device to the second device.

From step 413, process flow moves to step 417 in which it is determined whether a connection to the conference call through the second device was successful. If it is determined that a connection to the conference call through the second device was successful, the connection is established in step 425. Establishing the connection may include allowing the participant to join the conference call using the connection. Once the connection to the conference call is established through the second device, the connection to the conference call through the first device is terminated in step 429. The termination may generally be effectuated by either the participant or the conference call system. After the connection to the conference call through the first device is terminated, the participant remains connected to the conference using the second device in step 433, and the process of participating in a conference call is completed.

Returning to step 417, if the determination is that the connection using the second device was not successful, an indication of the lack of success may be provided to the participant in step 421 as an error indication. The participant remains connected to the conference call through the first device in step 437, and the process of participating in a conference call is completed.

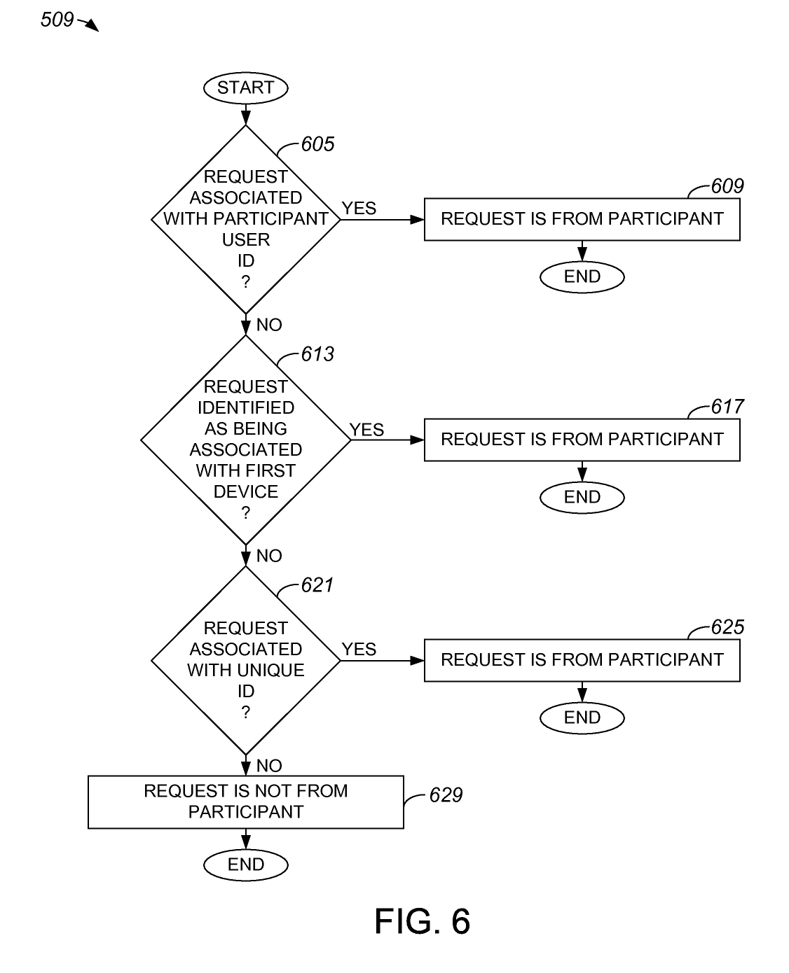

A conference call system, as previously mentioned, is generally arranged to recognize when a particular participant is requesting to transition from a first connection to a conference call through a first device to a second connection to the conference call through a second device. That is, a conference call system may identify a request to join a conference call as a request from an already-connected participant for an alternative connection through a different device. FIGS. 5A and 5B are a process flow diagram which illustrates a method of processing a request for an alternative connection to a conference call in accordance with an embodiment of the present invention. A method 501 of processing a request for an alternative connection begins at step 505 in which the conference call system maintains a first connection with the participant through a first device, i.e., a first device associated with the participant. The first connection enables the participant to participate in a conference call using the first device.

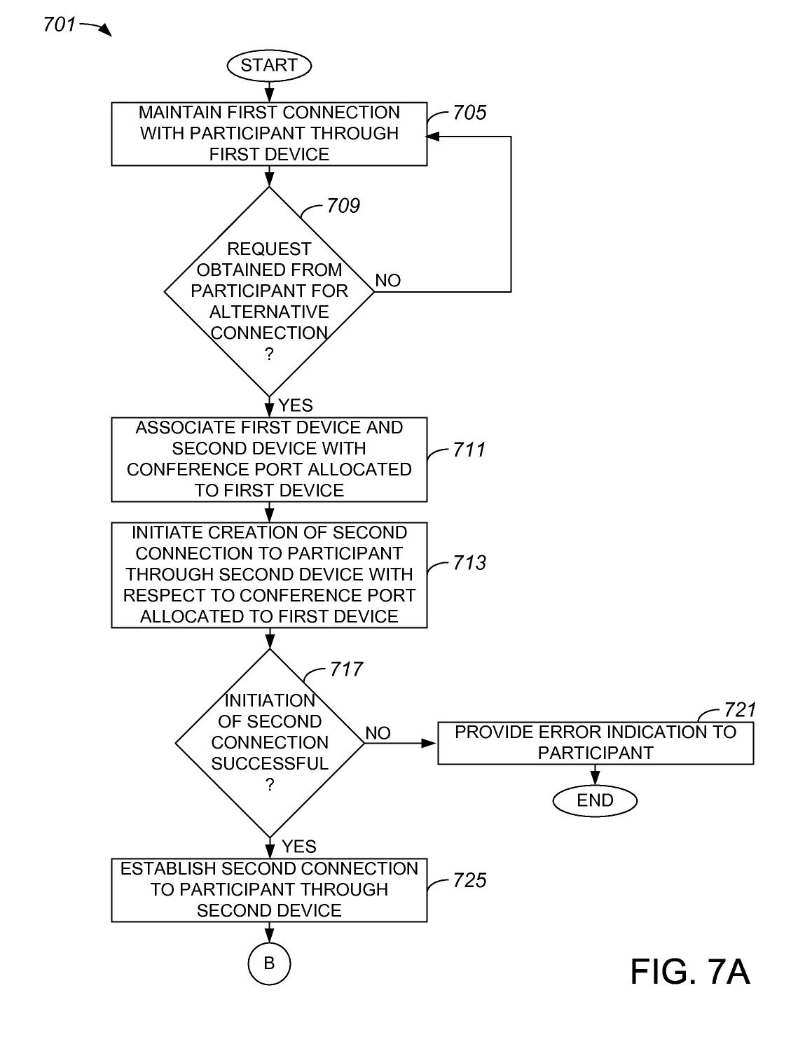

A determination is made in step 509 as to whether a request for an alternative connection to the conference call has been obtained, e.g., received, from the participant. Such a request may be obtained through a user interface provided by the conference call system. The user interface may be any suitable user interface including, but not limited to, those associated with a web request interface, an e-mail interface, a short message service (SMS) interface, a chat interface, and a dual-tone multi-frequency (DTMF) interface. The conference call system may determine whether a request for an alternative connection is received from a participant by ascertaining that the participant has provided an alternative telephone number, that the participant has used a menu to select an alternative device, or that the participant has entered a unique identifier which indicates that the request is from the participant. One method of determining whether a request for an alternative connection to the conference call has been obtained from the participant will be described below with respect to FIG. 6. It should be appreciated, however, that other methods for requesting an alternative connection may be used.

If it is determined that no request for an alternative connection has been obtained from the participant, process flow returns to step 505 in which the first connection with the participant continues to be maintained. Alternatively, if it is determined that a request for an alternative connection has been obtained from the participant, the establishment of a second connection between the participant and the conference call system in step 513 is initiated. That is, a connection, e.g., an alternative connection, to the conference call for the participant through the second device is initiated. In one embodiment, the conference call system may initiate the establishment of the second connection by effectively dialing a telephone number associated with the second device. It should be appreciated, however, that the participant may instead dial into the conference call using the second device to initiate the establishment of the second connection.

After the establishment of the second connection is initiated, it is determined in step 517 whether the establishment of the second connection was successful. If it is determined that the establishment of the second connection was not successful, the conference call system provides an error indication to the participant in step 521, and process flow returns to step 505 in which the first connection with the participant through the first device is maintained.

Alternatively, if it is determined in step 517 that the initiation of the second connection was successful, the second connection is established in step 525. Establishing the second connection may include joining the participant to the conference call using the second device. For an embodiment in which the conference call allows for substantially only a limited number of participants, establishing the second connection may include temporarily allocating additional resources to the participant. In another embodiment, when conferencing resources are limited, the first connection is torn down before the second connection is established in order to free up resources for use with respect to the second connection.

In the described embodiment, the participant is given the opportunity to terminate the first connection. Hence, from step 525, process flow moves to step 529 in which it is determined whether the first connection has been disconnected or terminated by the participant, although it should be appreciated that the conference call system may instead substantially automatically terminate the first connection. If it is determined that the first connection has been terminated by the participant, then the conference call system may optionally suppress an announcement process, e.g., an announcement process that announces when any participant joins or leaves a conference call, in step 533. The suppression of an announcement process is such that the termination of the first connection and the establishment of the second connection are effectively not announced and are, therefore, substantially stealth or transparent. It should be understood that if a conference call system does not support an announcement process, then an announcement process need not be suppressed. On the other hand, if a conference call system supports an announcement process, the announcement process may typically be suppressed to allow the participant to transfer from the first device to the second device without other conference call participants becoming aware of the transfer.

The conference call system maintains the second connection with the participant through the second device in step 549, and the method of processing a request for an alternative connection is completed. While the second connection, which has been added to the conference bridge, is maintained, the participant may participate in the conference call using the second device.

Returning to step 529 and the determination of whether the first connection has been terminated by the participant, if it is determined that the first connection has not been terminated by the participant, a determination is then made in step 537 as to whether a predetermined time period has expired. In one embodiment, a participant is provided with a predetermined time period during which the participant may terminate the first connection, as for example by effectively hanging up the first device. The predetermined time period may also serve the purpose of allowing for time between hanging up the first device and entering on the second device.

If the predetermined time period expires after establishing a second connection and before the participant terminates the first connection, then the conference call system may terminate the first connection. As such, if it is determined in step 537 that the predetermined time period has expired, the conference call system terminates the first connection in step 541, and optionally suppresses an announcement process in step 545. Terminating the first connection may include dropping the call associated with the first device, and adding the call associated with the second device to a conference bridge. As previously mentioned, an announcement process may be suppressed by a conference call system which supports an announcement process such that the establishment of the second connection and the termination of the first connection may remain transparent to other participants on a conference call. The conference call system maintains the second connection with the participant through the second device in step 547, and the method of processing a request for an alternative connection is completed.

With reference to FIG. 6, a method of determining whether a request obtained for a connection to a conference call is a request obtained from a participant who already has an established connection, e.g., step 509 of FIG. 5A, will be described in accordance with an embodiment of the present invention. A process 509 of determining whether a request for a connection is a request for an alternative connection begins at step 605 in which it is determined by a conference call system whether the request is associated with a user identifier of the participant, i.e., the participant who is already joined into a conference call through a first device. In one embodiment, a conference call system may have access to a datastore arrangement in which information relating to potential conference call participants may be stored. Such information may include a list of substantially all devices owned by, assigned to, or otherwise associated with each potential conference call participant. The information may also include other uniquely identifiable items including, but not limited to, an e-mail identifier. Each potential conference call participant may be assigned a substantially unique user identifier.

A determination of whether a request is associated with the user identifier of a participant may generally include determining whether the second device specified in the request is associated with the user identifier. If it is determined that the request is associated with the user identifier of the participant, the request is identified as being from the participant in step 609 and, hence is a request from the participant for an alternative connection. After the request is identified as being from the participant, the process of determining whether a request for a connection is a request for an alternative connection is completed.

Alternatively, if it is determined in step 605 that the request is not associated with the user identifier of the participant, process flow proceeds to step 613 in which it is determined whether the request is identified as being associated with the first device. In one embodiment, determining if the request is identified as being associated with the first device includes determining whether the originator of the request identified himself or herself as already being connected to a conference call through the first device. It should be appreciated that information provided as a part of a request may be entered via a user interface associated with the conference call system. If the request is identified as being associated with the first device, then the request is identified as being from the participant in step 617, and the process of determining whether a request for a connection is a request for an alternative connection is completed.

On the other hand, if it is determined in step 613 that the request is not identified as being associated with the first device, then a determination is made in step 621 as to whether the request is associated with a unique identifier of the participant who already has a first connection to a conference call through the first device. A unique identifier, as described above with respect to FIG. 4, is generally arranged to uniquely identify a conference call participant. A determination of whether a request is associated with a unique identifier or, more particularly, a unique identifier associated with a participant who already has a first connection to a conference call through the first device, may include determining whether the unique identifier was indicated in the request.

If the determination in step 621 is that the request is associated with a unique identifier which identifies the participant, then the request is identified as being from the participant in step 625, and the process of determining whether a request for a connection is a request for an alternative connection is completed. Alternatively, if it is determined in step 621 that the request is not associated with a unique identifier which identifies the participant, then the request is identified as not being from the participant in step 629, and the process of determining whether a request for a connection is a request for an alternative connection is completed. It should be appreciated that steps 609, 617, and 625 have been described as performing similar functions, although the functions performed by steps 609, 617, and 625 may instead be performed by essentially the same logic.

Some conference call systems include conferences bridges which provide for a limited capacity. Conferences bridges with a limited capacity allow for substantially only a pre-assigned number of participants in a conference call. When a maximum number of participants is present on a conference call, no additional participants and, hence, no additional connections, may be added to the conference call. However, seamless transition functionality included in a conference call system may be arranged to enable a conference call participant to transition from a first connection to a second connection even if no additional connections to be added to the conference call.

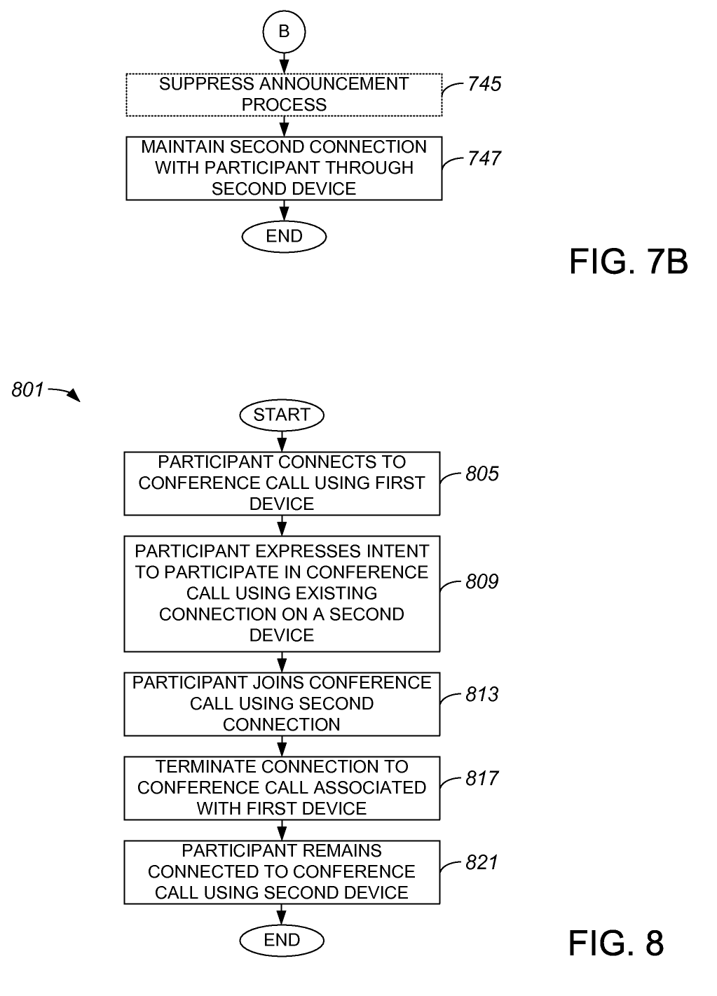

FIGS. 7A and 7B are a process flow diagram which illustrates a method of processing a request for an alternative connection to a conference call in a system in which there is a fixed number of participants in accordance with an embodiment of the present invention. A method 701 of processing a request for an alternative connection begins at step 705 in which the conference call system maintains a first connection with the participant through a first device associated with the participant. The first connection may be associated with a particular conference port associated with the conference call system.

A determination is made in step 709 as to whether a request for an alternative connection to the conference call has been obtained from the participant. Such a request may be obtained through a user interface provided by the conference call system. If it is determined that there has been no request for an alternative connection has been obtained from the participant, process flow returns to step 705 in which the first connection with the participant continues to be maintained, and the participant continues to participate in the conference through the first device.

Alternatively, if it is determined that a request for an alternative connection has been obtained from the participant, then the conference call system associates the first device with a second device, i.e., the device through which an alternative connection is requested, in step 711. Once the association has been established, the system may effectively disconnect a first connection, e.g., first connection 120a of FIG. 1C, and reserve freed up resources for the establishment of a second connection, e.g., second connection 120b of FIG. 1C. By associating the first device with the second device, the conference call system may effectively allow the second device to attempt to connect to a conference call system on the conference court allocated to the first device.

From step 711, process flow proceeds to step 713 in which the creation of a second connection through the second device is initiated substantially using the conference port allocated to the first device. The creation of the second connection may be initiated by the conference call system, e.g., the conference call system may dial a telephone number associated with the second device, such that a successful connection may be established with respect to the conference port allocated to the first device.

Once the creation or the establishment of the second connection is initiated, it is determined in step 717 whether the initiation of the second connection was successful. If it is determined that the initiation of the second connection was not successful, the conference call participant provides an error indication to the participant in step 721, and the processing of a request for an alternative connection is completed. In the described embodiment, the first connection was effectively disconnected approximately when the second connection was initiated. The first connection, however, is not limited to being effectively disconnected approximately when the second connection is initiated, e.g., the first connection may remain connected until a second connection is successfully established.

Alternatively, if it is determined in step 717 that the initiation of the second connection was successful, the second connection is established through the second device on the conference port allocated to the first device in step 725. In the described embodiment, to free up resources for the second connection, the first connection was effectively disconnected. It should be understood, however, that in some cases, the first connection may be disconnected after the second connection is established. An announcement process is optionally suppressed in step 745. An announcement process may be suppressed if the conference call system supports an announcement process, and process flow may then move to step 747 in which the second connection is maintained. On the other hand, if the conference call system does not support an announcement process, then process flow moves directly from step 741 to step 747 in which the second connection is maintained. The method of processing a request for an alternative connection is completed upon the second connection being maintained.

In one embodiment, a participant may join a conference call using a first device, and then transparently switch to participating in the conference call through a second device which is already connected to the conference call. By way of example, a participant may join a conference call through his or her mobile telephone, walk into a conference room in which others have joined the conference call using a speaker telephone, and then transparently switch to participating on the conference call using the speaker telephone without triggering an announcement process when he or she hangs up the mobile telephone. If the participant indicates to a conference call system, i.e., the conference call system that supports the conference call, the he or she wishes to switch from participating using his or her mobile phone to participating via the already connected speaker telephone, the conference call system may suppress the announcement process. Hence, an announcement related to the dropping of the mobile telephone from the conference call may be suppressed.

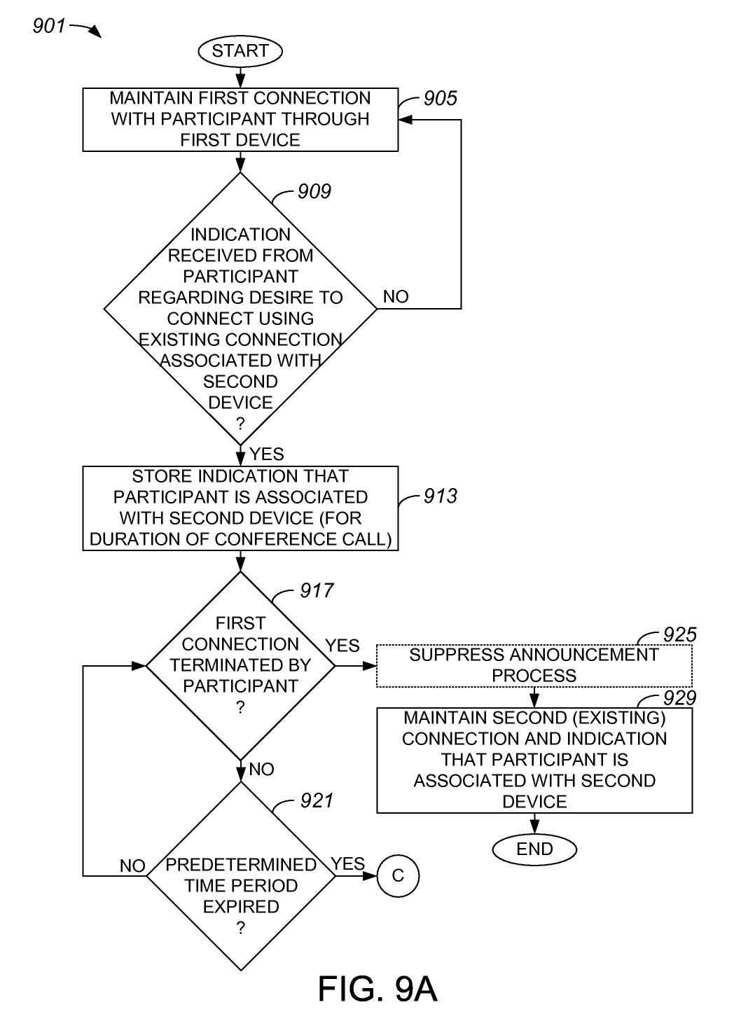

FIG. 8 is a process flow diagram which illustrates a method of seamlessly transitioning from a conference call connection associated with a first device to an existing conference call connection from the point of view of a participant in accordance with an embodiment of the present invention. A method 801 of transitioning from one conference call connection to another pre-existing conference call connection begins at step 805 in which a participant connects to a conference call using a first device, as for example a mobile telephone. Once connected, the participant may participate in the conference call.

In step 809, the participant expresses an intent to continue participating in a conference call, but through using an existing connection on a second device. By way of example, the participant may express an intent to switch from participating on a conference call using his or her mobile telephone to participating on the conference call via a telephone which is already connected to the conference call. An intent to continue participating but through using an existing connection may be expressed by the participant through a user interface provided by a conference call system. For instance, the participant may access menus provided by the conference call system using the first device, and use the menus to indicate that he or she wishes to drop the connection associated with the first device and join an already established connection associated with the second device.

After the participant expresses the intent to participate in the conference call using the existing connection on the second device, the participant joins the conference call in step 813 using the connection associated with the second device. Then, in step 817, the connection to the conference call associated with the first device is terminated. In general, either the participant or the conference call system may terminate the connection associated with the first device. Upon terminating the connection associated with the first device, the participant remains connected to the conference call using the second device in step 821, and the method of transitioning from one conference call connection to another pre-existing conference call connection is completed.

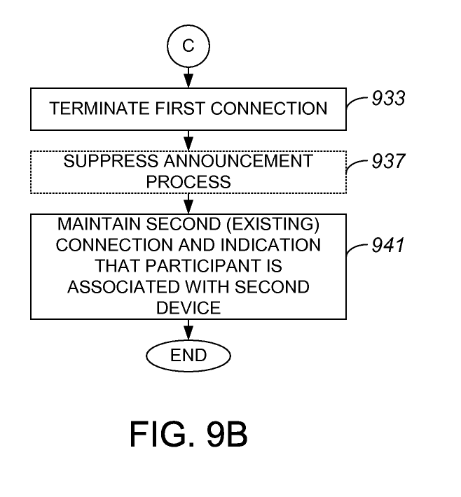

Referring next to FIGS. 9A and 9B, the operation of a conference call system relative to supporting a seamless transition from a conference call connection associated with a first device to an existing conference call connection will be described from the point of view of the conference call system in accordance with an embodiment of the present invention. A method 901 of transitioning a participant from one conference call connection to another pre-existing conference call connection begins at step 905 in which a conference call system maintains a first connection with the participant through a first device that enables the participant to participate in a conference call. In step 909, a determination is made as to whether an indication has been received from the participant regarding his or her desire to instead connect to the conference call using a different, already existing connection associated with a second device. That is, it is determined in step 909 whether the participant has requested a transition from his or her connection through the first device to an already existing connection through the second device.

If it is determined in step 909 that no indication of a desire to transition to a different connection has been obtained, process flow returns to step 905 in which the first connection through the first device is maintained. Alternatively, if it is determined that an indication of a desire to transition to a different connection has been obtained, then the conference call system may store an indication that the participant is associated with the second device in step 913. That is, the conference call system may effectively note that the participant is connected to the conference call through the second device for the duration of the conference call.

After an indication that the participant is associated with the second device is stored, it is determined in step 917 whether the first connection has been terminated by the participant. In the described embodiment, the participant is provided with the opportunity to terminate the first connection, although it should be appreciated that in an alternative embodiment, the conference call system may be arranged to substantially automatically terminate the first connection.

If the determination in step 917 is that the first connection has been terminated by the participant, the conference call system optionally suppresses an announcement process in step 925. As mentioned above, if the conference call system supports an announcement process, the announcement process is typically suppressed or otherwise prevented from being triggered. Suppressing the announcement process may include suppressing an announcement that the participant has left the conference call. The conference call system maintains the second connection through the second device, as well as the indication that the participant is associated with the second device in step 929, and the method of transitioning a participant from one conference call connection to another pre-existing conference call connection is completed.

Returning to step 917, if it is determined that the first connection has not been terminated by the participant, a determination is then made in step 921 as to whether a predetermined time period has expired. The predetermined time period is a time period during which the participant may terminate the first connection. After the predetermined time period expires, the first connection is typically automatically terminated by the conference call system.

If it is determined in step 921 that the predetermined time period has not expired, process flow returns to step 917 in which it is determined whether the first connection has been terminated by the participant. On the other hand, it if is determined in step 921 that the predetermined time period has not expired, then the conference call system terminates the first connection in step 933. An announcement process is then optionally suppressed in step 937, and the second connection is maintained in step 941, along with an indication that the participant is associated with the second device. The process of transitioning a participant from one conference call connection to another pre-existing conference call connection is completed after the second connection is maintained.

Although only a few embodiments of the present invention have been described, it should be understood that the present invention may be embodied in many other specific forms without departing from the spirit or the scope of the present invention. By way of example, although a first connection to a conference call may be manually terminated by a conference call participant after a second connection to the conference call for the participant is established, a conference call system may substantially automatically terminate the first connection upon establishing the second connection. In other words, the conference call system may effectively simultaneously establish the second connection and end the first connection such that a participant essentially never has more than a single connection at any given time.

The ability to seamlessly transition between two devices associated with a participant has generally been described as being associated with a conference call system. It should be appreciated, however, that the ability to seamlessly transition between two devices associated with a participant is not limited to being associated with a conference call system. For example, the ability to seamlessly transition between two devices may be associated with substantially any application which has conferencing capabilities. Such applications may include, but are not limited to including, a call manager system as well as an interoperability and collaboration system.

In general, a conference call participant may seamlessly transition between more than two different devices. That is, a conference call participant is not limited to switching from a first device or endpoint to a second device or endpoint. For instance, a conference call participant may connect to a conference call using a desktop telephone in his or her office, switch to a connection associated with a mobile telephone while moving from his or her office to a conference room, and then switch to a connection associated with a speaker telephone in the conference room.

A unique identifier that is assigned to a participant may be substantially any identifier. For example, a unique identifier may be a user name of a participant, a telephone number associated with a device of a participant, and/or any substantially unique string of characters. In one embodiment, whether than a conference call system assigning a unique identifier to a participant, a participant may instead provide a desired unique identifier to the conference call system via a suitable user interface.

A conference call system that supports transitioning between connections associated with a particular participant has been described separately from a conference call system that supports transitioning from a connection associated with a particular participant to another existing connection. However, a single conference call system may be arranged to support both transitioning between connections associated with a particular participant and transitioning from a connection associated with a particular participant to another existing connection. In one embodiment, the steps associated with FIGS. 5A and 5B may be substantially combined with the steps associated with FIG. 9.

In one embodiment, when a conference call participant using a first endpoint indicates a desire, i.e., to a conference call system, to continue to participate on the conference call but through a second endpoint instead of the first endpoint, the conference call system may provide the participant with a new conference call identifier. While the participant is still participating in the conference call through the first endpoint, he or she may dial into a conference bridge using the second endpoint, and provide the new conference call identifier to the conference bridge, e.g., through the use of a breakout menu associated with the conference call system or through the use of other suitable interfaces. In response to the participant dialing into the conference bridge using the second endpoint, the conference call system may substantially automatically drop the call associated with the first endpoint, and add the call associated with the second endpoint to the conference bridge. The conference call participant may suppress announcements such that no announcements regarding the dropping of the first endpoint from the conference bridge, and the addition of the second endpoint to the conference bridge, are played.

The steps associated with the methods of the present invention may vary widely. Steps may be added, removed, altered, combined, and reordered without departing from the spirit of the scope of the present invention. By way of example, a unique identifier has been described as being substantially assigned to a conference call participant when the conference call participant connects to a conference call. It should be appreciated, however, that the unique identifier may instead be assigned to the conference call participant when the conference call participant indicates a desire to connect to the conference call using a different device. Therefore, the present examples are to be considered as illustrative and not restrictive, and the invention is not to be limited to the details given herein, but may be modified within the scope of the appended claims.

What is claimed is:

1. A method comprising:
maintaining a first connection with respect to a conference call, the first connection being maintained through a first endpoint, wherein the first endpoint is associated with a user;
determining if the user has requested a second connection with respect to the conference call; and
replacing the first connection with the second connection with respect to the conference call if the user has requested the second connection, wherein replacing the first connection with the second connection includes establishing the second connection with respect to the conference call, the second connection being established through a second endpoint, wherein the second endpoint is associated with the user, and wherein the second connection replaces the first connection transparently with respect to the conference call.

2. The method of claim 1 wherein replacing the first connection with the second connection further includes causing the first connection to be disconnected approximately when the second connection is established, wherein the first connection is disconnected transparently with respect to the conference call, and wherein the second connection is established transparently with respect to the conference call.

3. The method of claim 2 wherein the first connection is disconnected just after the second connection is established.

4. The method of claim 2 wherein the first connection is disconnected just before the second connection is established.

5. The method of claim 2 wherein causing the first connection to be disconnected transparently with respect to the conference call includes suppressing an announcement which indicates that the first connection has been disconnected from being broadcast relative to the conference call.

6. The method of claim 2 further including:
maintaining the second connection after causing the first connection to be disconnected.

7. The method of claim 2 wherein maintaining the first connection with respect to the conference call includes maintaining the first connection to a conference bridge, the conference bridge being arranged to support the conference call and wherein establishing the second connection with respect to the conference call includes maintaining the first connection to the conference bridge.

8. The method of claim 2 wherein causing the first connection to be terminated includes causing the first connection to be terminated approximately at a first time, and wherein establishing the second connection includes establishing the second connection at approximately the first time.

9. The method of claim 1 wherein establishing the second connection with respect to the conference call includes suppressing an announcement which indicates that the second connection has been established from being broadcast relative to the conference call.

10. The method of claim 1 wherein the user has an identifier, the first device being associated with the identifier, and wherein determining if the user has requested a second connection with respect to the conference call includes determining if the second device is associated with the identifier.

11. The method of claim 10 further including:
assigning the identifier to the user.

12. The method of claim 1 further including:
providing an interface, wherein the user may request the second connection using the interface.

13. The method of claim 1 wherein establishing the second connection with respect to the conference call includes initiating the second connection.

14. The method of claim 1 wherein establishing the second connection with respect to the conference call includes receiving a call initiated from the second endpoint.

15. Logic encoded in one or more tangible media for execution and when executed operable to:
maintain a first connection with respect to a conference call, the first connection being maintained through a first endpoint, wherein the first endpoint is associated with a user;
determine if the user has requested a second connection with respect to the conference call; and
replace the first connection with the second connection with respect to the conference call if the user has requested the second connection, wherein the logic operable to replace the first connection with the second connection is further operable to establish the second connection with respect to the conference call, the second connection being established through a second endpoint, wherein the second endpoint is associated with the user, and wherein the second connection replaces the first connection transparently with respect to the conference call.

16. The logic of claim 15 wherein the logic operable to replace the first connection with the second connection is further operable to cause the first connection to be disconnected approximately when the second connection is established, wherein the first connection is disconnected transparently with respect to the conference call, and wherein the second connection is established transparently with respect to the conference call.

17. The logic of claim 16 wherein the first connection is disconnected just after the second connection is established.

18. The logic of claim 16 wherein the first connection is disconnected just before the second connection is established.

19. The logic of claim 15 wherein the logic operable to maintain the first connection with respect to the conference call is further operable to maintain the first connection to a conference bridge, the conference bridge being arranged to support the conference call and wherein the logic operable to establish the second connection with respect to the conference call is further operable to maintain the first connection to the conference bridge.

20. The logic of claim 15 wherein the logic operable to cause the first connection to be disconnected transparently with respect to the conference call is further operable to suppress an announcement which indicates that the first connection has been disconnected from being broadcast relative to the conference call.

21. The logic of claim 15 wherein the logic operable to establish the second connection transparently with respect to the conference call is further operable to suppress an announcement which indicates that the second connection has been established from being broadcast relative to the conference call.

22. The logic of claim 15 wherein the logic operable to establish the second connection with respect to the conference call is further operable to initiate the second connection.

23. The logic of claim 15 wherein the logic operable to establish the second connection with respect to the conference call is further operable to receive a call initiated from the second endpoint.

24. An apparatus comprising:
means for maintaining a first connection with respect to a conference call, the first connection being maintained through a first endpoint, wherein the first endpoint is associated with a user;
means for determining if the user has requested a second connection with respect to the conference call; and
means for replacing the first connection with the second connection with respect to the conference call if the user has requested the second connection, wherein replacing the first connection with the second connection includes establishing the second connection with respect to the conference call, the second connection being established through a second endpoint, wherein the second endpoint is associated with the user, and wherein the second connection replaces the first connection transparently with respect to the conference call.

25. The apparatus of claim 24 wherein the means for maintaining the first connection with respect to the conference call include means for maintaining the first connection to a conference bridge, the conference bridge being arranged to support the conference call and wherein the means for establishing the second connection with respect to the conference call include means for maintaining the first connection to the conference bridge.

26. The apparatus of claim 24 further including:
means for causing the first connection to be disconnected transparently with respect to the conference call, wherein the means for causing the first connection to be disconnected transparently include means for suppressing an announcement which indicates that the first connection has been disconnected from being broadcast relative to the conference call.

27. The apparatus of claim 26 wherein the means for establishing the second connection transparently with respect to the conference call include means for suppressing an announcement which indicates that the second connection has been established from being broadcast relative to the conference call.

28. An apparatus comprising:
a conference bridge arrangement, the conference bridge arrangement being configured to support a conference call to which a first device is connected, the first device being associated with a user;
an announcement arrangement, the announcement arrangement being configured to implement an announcement process; and
seamless transition logic, the seamless transition logic being configured to determine when the user requests that a second device be connected to the conference bridge arrangement, the second device being associated with the user, the seamless transition logic further being configured to cause the second device to be connected to the conference call and to cause the first device to be disconnected from the conference call approximately when the second device is connected to the conference call, wherein the seamless transition logic suppresses the announcement process with respect to announcing that the first device has been disconnected and that the second device has been connected.

29. The apparatus of claim 28 wherein the seamless transition logic is configured to cause the second device to be connected to the conference call by dialing out to the second device.

30. The apparatus of claim 28 wherein the seamless transition logic is configured to identify the second device as being associated with the user.

31. The apparatus of claim 30 wherein the seamless transition logic is configured to identify the first device as being associated with the user

32. The apparatus of claim 28 further including:
an interface arrangement, the interface arrangement being configured to enable the user to request that the second device be connected to the conference call.
